(19) United States
(12) Patent Application Publication
(10) Pub. No.: US 2015/0143948 A1
(43) Pub. Date: May 28, 2015

(54) Cam Follower Device

(71) Applicants: Benoît Hauvespre, Saint Etienne de Chigny (FR); Aurelien Ghilbert-Simon, Saint Roch (FR)

(72) Inventors: Benoît Hauvespre, Saint Etienne de Chigny (FR); Aurelien Ghilbert-Simon, Saint Roch (FR)

(73) Assignee: AKTIEBOLAGET SKF, Goteborg (SE)

(21) Appl. No.: 14/554,523

(22) Filed: Nov. 26, 2014

(30) Foreign Application Priority Data
Nov. 26, 2013 (FR) 1361619

(51) Int. Cl. F16H 53/06

(52) U.S. Cl. CPC F16H 53/06
USPC 74/569

(57) ABSTRACT

The cam follower roller device comprises a body 12, a roller 14, and a shaft 16 mounted on the body 12 and comprising an outer seat for mounting the roller to rotate. The roller comprises an inner surface 14a radially surrounding the seat and is mounted able to rotate with respect to the shaft. The outer seat of the shaft and/or the inner surface 14a of the roller comprise a plurality of cavities. The ratio of the sum of the surfaces areas of the cavities to the total surface area of the outer seat, or of the inner surface, in which the cavities are formed is between 2% and 40%. The cavities have a depth between 0.5 μm and 5 μm.

### FIELD OF THE INVENTION

The present invention relates to the field of cam follower roller devices used in automotive or industrial applications.

### BACKGROUND OF THE INVENTION

One advantageous application of the invention is the use of the cam follower roller device in a fuel injection pump intended for an internal combustion engine, in particular of a motor vehicle such as an automobile or lorry.

A device such as this comprises a tappet or body and a roller mounted to rotate on the body and intended to cooperate with a cam synchronized with the camshaft of the internal combustion engine so that the rotation of the camshaft leads to a periodic displacement of a piston of the injection pump that bears against the body, to allow fuel to be delivered.

Another advantageous application of the invention is the use of the device in a rocker system intended for controlling the valves of an internal combustion piston engine.

In this application, the roller of the device is intended to cooperate, by rolling on it, with a cam of the camshaft of the internal combustion engine so that the rotation of the camshaft causes a periodic pivoting of a body of the device or of a rocker body, to open and close valves of the engine.

For these devices, a continuous oil supply for lubricating the contact zone between the roller and a shaft which supports this roller is generally provided during the operation of the internal combustion engine.

In order to reduce the costs associated with the use of such devices, it is desirable to minimize the flow of lubricating oil. Moreover, in certain applications, the cam follower roller devices must be operational even during transient periods in which the supply of oil is interrupted or in which the oil has not yet reached the contact zone between the roller and the support shaft, for example during the start-up of the combustion engine.

### SUMMARY OF THE INVENTION

The present invention aims to provide a cam follower roller device which meets these requirements.

More particularly, the present invention aims to provide a device requiring a limited supply of lubricant.

The present invention further aims to provide a device which is simple to manufacture and to assemble, is of reduced overall size and has a limited number of components.

In one embodiment, the cam follower roller device comprises a body, a roller, and a shaft mounted on the body and comprising an outer seat for mounting the roller to rotate. The roller comprises an inner surface radially surrounding the outer seat and is mounted able to rotate with respect to the shaft. The outer seat of the shaft and/or the inner surface of the roller comprise a plurality of cavities. The ratio of the sum of the surface areas of the cavities to the total surface area of the outer seat, or of the inner surface, in which the cavities are formed is between 2% and 40%. The cavities have a depth between 0.5 micrometres (μm) and 5 micrometres (μm).

Preferably, the ratio is between 5% and 15%.

The cavities may have a profile in the form of a spherical cap. The diameter of the cavities may, for example, be between 20 μm and 80 μm.

In one embodiment, the inner surface of the roller is mounted radially in contact with the outer seat of the shaft.

In another embodiment, the device also comprises a plain bearing interposed radially between the outer seat of the shaft and the inner surface of the roller. An outer surface of the plain bearing may be mounted radially in contact with the inner surface of the roller and may comprise a plurality of cavities. Alternatively or in combination, an inner surface of the plain bearing may be mounted radially in contact with the outer seat of the shaft and may comprise a plurality of cavities. The ratio of the sum of the surface areas of the cavities in the outer surface, or in the inner surface, of the plain bearing to the total surface area of the surface on which the cavities are formed may advantageously be between 2% and 40%, the cavities having a depth between 0.5 μm et 5 μm.

In one embodiment, the ends of the shaft are fixed in holes in the body. Alternatively, the device may additionally comprise a support fixed to the body and provided with open bearing journals supporting the ends of the shaft.

In one embodiment, the surfaces provided with the cavities, selected from the outer seat of the shaft and/or the inner surface of the roller, are covered using a surface treatment which may consist of a carbon-based coating layer, such as diamond-like amorphous carbon which is known internationally under the designation DLC, or of a tungsten disulphide (WS₂)-based coating layer, or else of a black oxide-type oxidation (“black oxidizing”).

### BRIEF DESCRIPTION OF THE INVENTION

The present invention will be better understood on reading the detailed description of embodiments given by way of non-limiting examples and illustrated by the appended drawings, in which:

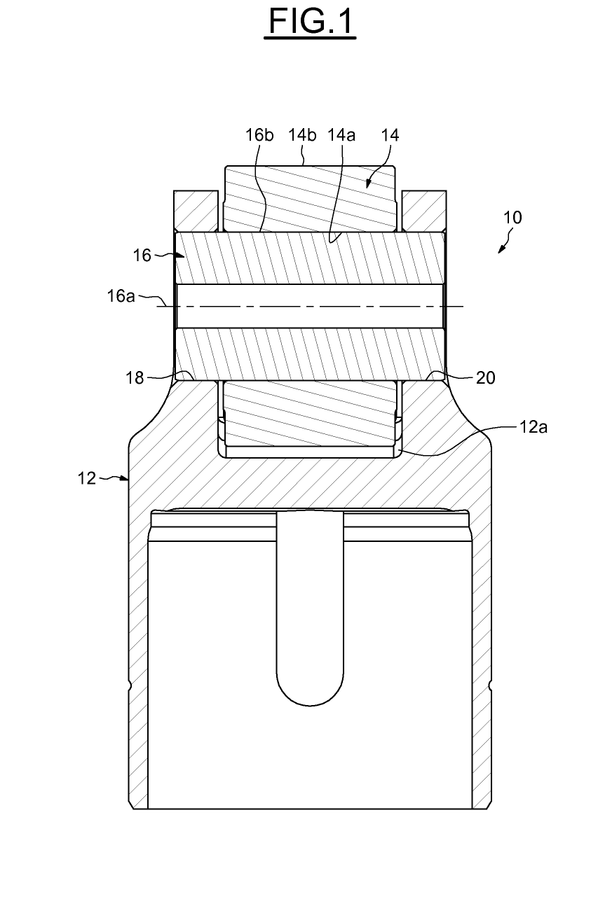

FIG. 1 is a view in section of a cam follower roller device according to a first example of the invention,

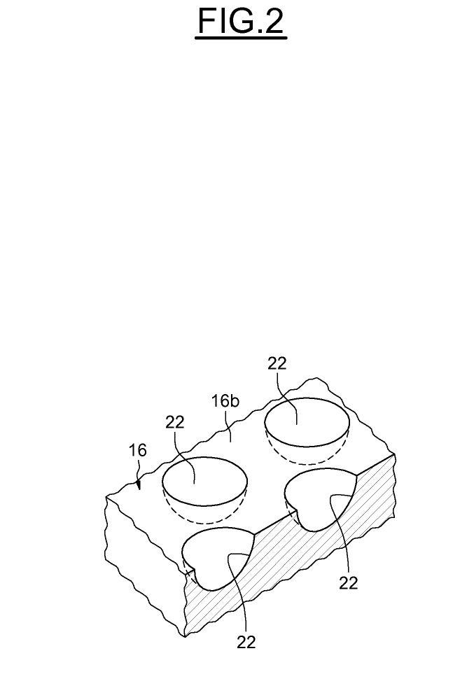

FIG. 2 is a detail view illustrating the outer surface of a shaft of the device of FIG. 1, and

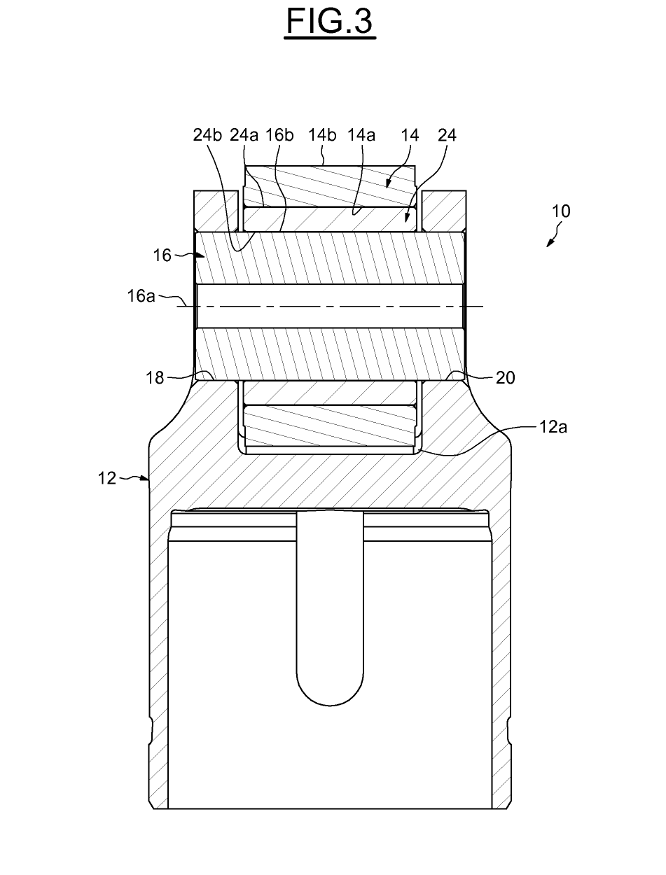

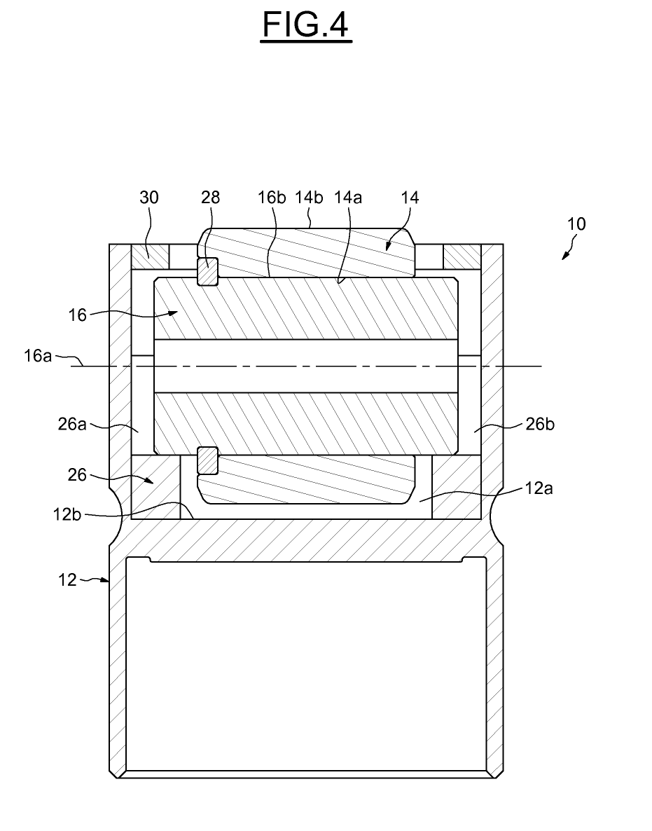

FIGS. 3 and 4 are views in section of cam follower roller devices according to a second and a third example of the invention.

### DETAILED DESCRIPTION OF THE INVENTION

FIG. 1 shows a cam follower roller device, designated by the general reference number 10, which can for example be used in a fuel injection pump intended for an internal combustion engine.

The device 10 comprises a tappet or body 12 and a roller 14 mounted to rotate with respect to the body and intended to bear against a cam synchronized with the camshaft of the internal combustion engine or directly against a cam of the shaft. The body 12 delimits an outwardly open recess 12a inside which the roller 14 is mounted. The roller 14 extends so as to project radially outside the body 12. The body 12 may advantageously be obtained at a low cost by forging or by cutting, stamping and bending from a blank of thin metal sheet.

The device 10 also comprises a shaft 16, of geometric axis 16a, mounted on the body 12 and supporting the roller 14. The support shaft 16 comprises an axial cylindrical outer surface 16b on which the roller 14 is mounted. The shaft 16 extends axially on either side of the roller 14. The ends of the shaft 16 are mounted inside through-holes 18, 20 formed in the body 12 axially opposite one another. The shaft 16 is fixed by any suitable means to the body 12. The portion of the outer surface 16b left free by the body 12 forms an outer mounting bearing surface or outer seat for the roller 14. The outer seat is situated axially between the ends of the shaft 16 housed inside the holes 18, 20 in the body.

The roller 14 is mounted in a freely rotating manner on the outer seat of the shaft 16. In the exemplary embodiment illustrated, the roller 14 is also mounted in a freely translating manner on the outer seat of the shaft 16. The roller 14 comprises an axial cylindrical bore 14a mounted in direct radial contact with the outer seat of the shaft 16 and forming an inner surface, and an axial cylindrical outer surface 14b radially opposed to the bore. The outer surface 40b of the roller forms a contact surface intended to bear against the associated cam of the internal combustion engine.

In order to be able to reduce the flow of lubricant intended for the contact zone between the roller 14 and the shaft 16 while allowing operation without lubricant supply during transient periods, a plurality of cavities 22 (FIG. 2) are formed in the outer seat of the shaft 16. The cavities 22 are formed starting from the outer surface 16b and extend radially inwards. The cavities 22 are oriented radially outwards and are open in the direction of the bore 14a of the roller. The cavities 22 form concave recesses made in the outer surface 16b of the shaft and are substantially globally identical to one another. The cavities 22 may be formed by a mechanical-impact treatment process of the shot-blasting type with balls made, for example, of steel, ceramic or else glass.

The cavities 22 are distributed over the outer seat of the shaft 16 such that the ratio of the sum of the surface areas of the walls delimiting the cavities 22 to the total surface area of the seat is between 2% and 40%. Preferably, the ratio is between 5% and 15%. Furthermore, the cavities 22 have a depth between 0.5 μm and 5 μm. In the exemplary embodiment illustrated, the cavities 22 have a profile in the form of a spherical cap. The cavities 22 may have, on the outer seat of the shaft 16, a diameter between 20 μm and 80 μm.

Under normal lubrication conditions, the cavities 22 of the shaft fill with lubricant and form reservoirs which may then allow a diffusion of the lubricant contained during transient periods in which the contact zone between the roller 14 and the shaft 16 is no longer supplied with lubricant.

The Applicant has determined that, with a degree of coverage and a depth as are defined above for the cavities 22, it is possible to reduce the flow of lubricant to be provided under normal lubrication conditions while maintaining satisfactory operation during transient periods without lubricant supply. The risks of premature wear, of seizing and frictional energy losses are thus substantially reduced. Moreover, the frictional torque between the roller 14 and the shaft 16 is also reduced.

In the exemplary embodiment described, the cavities 22 are made only in the seat of the outer surface 16a of the shaft on which the roller 14 is mounted. Specifically, the sliding interface between the shaft 16 and the roller 14 is formed by this seat and by the radially opposite bore 14a of the roller. For manufacturing reasons, it is, however, possible to provide such cavities in the entire outer surface 16b of the shaft.

Advantageously, it is possible to additionally provide cavities in the bore 14a of the roller which are formed starting from the bore and extend radially outwards. Such cavities are oriented radially inwards and are open in the direction of the outer surface 16b of the shaft. The degree of coverage defined by the ratio of the surface area of the cavities to the surface area of the bore 14a of the roller and also the depth of the cavities are identical to those defined above for the shaft 16. Thus, the flow of lubricant to be provided may again be reduced. In one variant embodiment, it could be possible to provide cavities only in the bore 14a of the roller.

The exemplary embodiment illustrated in FIG. 3, in which identical elements bear the same references, differs only in that the device 10 also comprises a plain bearing 24 interposed radially between the roller 14 and the shaft 16. The plain bearing 24 has an annular sleeve shape and is coaxial to the roller 14 and to the shaft 16. The bearing 24 comprises an axial cylindrical outer surface 24a mounted radially in contact with the bore 14a of the roller, and an opposed axial cylindrical bore 24b mounted radially in contact with the outer surface 16b of the shaft. The roller 14 is mounted on the shaft 16 via the bearing 24. The bearing 24 may be fixed to the roller 14 or to the shaft 16 or else mounted in a freely rotating manner between them.

The outer surface 24a of the plain bearing and/or the cylindrical bore 24b may comprise a plurality of cavities intended to form lubricant reserves in an identical manner to those provided in the outer seat of the shaft 16 on which the plain bearing 24 is mounted and/or in the bore 14a of the roller. In one variant embodiment, it could be possible to provide a needle bearing instead of the plain bearing.

The exemplary embodiment illustrated in FIG. 4, in which identical elements bear the same references, differs from the first exemplary embodiment described principally in that the device 10 comprises a support 26 mounted axially so as to bear against a bottom wall 12b of the body and comprising bearings or journals 26a, 26b which are open and oriented radially outwards. The support 26 is fixed to the body 12 by any suitable means. The journals 26a, 26b have a semicircular profile open radially outwards with a diameter corresponding to the diameter of the shaft 16. The shaft 16 is mounted radially in contact against the journals 26a, 26b of the support. A circlip 28 is fixed to the shaft 16 and bears axially against the roller 14. In the exemplary embodiment illustrated, a recess is formed on one of the front faces of the roller 14 in order to mount the circlip 28.

In this exemplary embodiment, the device 10 also comprises an annular retaining ring 30 fixed to the end of the body 12 in order to retain the roller 14 relative to the body during transport and assembly of the device 10. In the example illustrated, the retaining ring 30 is an add-on part fixed to the body 12. Alternatively, it could be possible to form, at the end of the body 12, one or more local deformations of material so as to prevent the roller 14 from moving out of the body 12 after assembly. In this exemplary embodiment, in an identical manner to the first and second exemplary embodiments, at least the outer seat of the shaft 16 on which the roller is mounted and/or the bore 14a of the roller comprise cavities as defined above.

The present invention has been illustrated on the basis of a cam follower roller device which can, for example, be used in a fuel injection pump intended for an internal combustion engine. It is also possible, without departing from the scope of the invention, to provide a cam follower roller device in a rocker system which is used for controlling valves of an internal combustion engine, and which comprises a shaft, a roller, or even a plain bearing, as defined above.

1. A cam follower roller device comprising:
a body,
a roller, and
a shaft mounted on the body and having an outer seat for mounting the roller to rotate, the roller providing an inner surface radially surrounding the seat and being mounted able to rotate with respect to the shaft, wherein
one of the outer seat of the shaft and the inner surface of the roller has a plurality of cavities, and one of the ratio of the sum of the surface areas of the cavities to the total surface area of the outer seat, and of the inner surface, in which the cavities are formed being between 2% and 40%, the cavities having a depth between 0.5 μm and 5 μm.

2. The device according to claim 1, wherein the ratio is between 5% and 15%.

3. The device according to claim 1, wherein the cavities have a profile in the form of a spherical cap.

4. The device according to claim 3, wherein the diameter of the cavities is between 20 μm and 80 μm.

5. The device according to claim 1, wherein the inner surface of the roller is mounted radially in contact with the outer seat of the shaft.

6. The device according to claim 1, further comprising a plain bearing disposed radially between the outer seat of the shaft and the inner surface of the roller.

7. The device according to claim 6, wherein an outer surface of the plain bearing is mounted radially in contact with the inner surface of the roller and includes a plurality of cavities.

8. The device according to claim 6, wherein an inner surface of the plain bearing is mounted radially in contact with the outer seat of the shaft and includes a plurality of cavities.

9. The device according to claim 7, wherein one of the ratio of the sum of the surface areas of the cavities of the outer surface and of the inner surface of the plain bearing to the total surface area of the surface on which the cavities are formed is between 2% and 40%, the cavities having a depth between 0.5 μm and 5 μm.

10. The device according to claim 1, wherein the ends of the shaft are fixed in holes in the body.

11. The device according to claim 1, further comprising a support fixed to the body and provided with open journals supporting the ends of the shaft.
